(19) United States
(12) Patent Application Publication
(10) Pub. No.: US 2024/0341317 A1
(43) Pub. Date: Oct. 17, 2024

(54) PROCESS FOR PRODUCTION OF A FERMENTED MILK PRODUCT USING GLUCOSE-FRUCTOSE OXIDOREDUCTASE

(71) Applicant: DSM IP Assets B.V., Heerlen (NL)

(72) Inventors: Petrus Jacobus Theodorus DEKKER, Echt (NL); Remon BOER, Echt (NL)

(21) Appl. No.: 18/291,819

(22) PCT Filed: Jul. 26, 2022
(86) PCT No.: PCT/EP2022/070912

§ 371 Date: Jan. 24, 2024

(30) Foreign Application Priority Data
Jul. 26, 2021 (EP) 21187587.7

(51) Int. Cl. A23C 9/12; A23C 9/123

(52) U.S. Cl. CPC A23C 9/1213; A23C 9/1216; A23C 9/123; C12Y 101/99028; C12Y 302/01026; A23V 2400/123; A23V 2400/249

(57) ABSTRACT

A process for the preparation of a fermented milk product comprising the steps of: —providing a milk base comprising glucose and fructose; and —fermenting the milk base in the presence of a lactic acid bacterial strain and a glucose-fructose oxidoreductase enzyme.

### FIELD OF THE INVENTION

The invention relates to a novel process for production of a fermented milk product, a starter culture for such a process and a product that can be obtained with such a process.

### BACKGROUND OF THE INVENTION

Lactic acid bacteria are extensively used for production of fermented milk products, and they greatly contribute to flavor, texture and overall characteristics of these products. An old and well known example is yoghurt which probably originated from the Middle East and which still makes up more than half of the fermented milk production—or approximately 19 million tons in 2008. Fermented milk products, such as yoghurts are popular due to the healthy image and pleasant sensory properties.

The preparation of fermented milk products, such as for example yoghurt, cream cheese or cottage cheese, involves multiple steps. Milk or a milk alternative may be heat treated (pasteurized) to remove oxygen and kill harmful bacteria, whereafter it is cooled again to prepare it for fermentation. During fermentation a starter culture comprising the lactic acid bacteria is added to the milk or milk alternative, allowing the fermentation to start and the fermented milk product to be produced. For example, starter cultures for yoghurt can comprise lactic acid bacteria such as Streptococcus thermophilus and Lactobacillus delbrueckii spp bulgaricus. In a conventional process, the lactic acid bacteria produce lactic acid via the consumption of lactose present in the milk or milk alternative.

In many parts of the world there is an increasing interest in fermented milk products with a mild taste. This poses significant challenges as in conventional processes, the lactic acid bacteria intrinsically produce lactic acid during the above fermentation process. During fermentation the production of lactic acid reduces the pH, adding an acidic flavor to the product. This is also referred to as the acidification of the fermented milk product. After fermentation the fermented milk product may be concentrated and/or stored. During these concentration and/or storage steps, the product can even acidify further. Such further acidification, also referred to as post-acidification, is considered highly undesirable as it may negatively influence the taste of the fermented milk product.

Organoleptic properties such as taste, firmness and mouthfeel of the dairy product are of great importance for customer acceptance. As indicated above, a mild taste is very desirable from a customer perspective

Fly et al, in their article titled “Use of glucono-delta-lactone in the manufacture of yoghurt”, published in the Australian Journal of Dairy Technology, vol. 52 (1997) page 20-23, describe that glucono-delta-lactone (GDL) is an acidogen which is hydrolysed to gluconic acid in aqueous solution. It was indicated that use of GDL in combination with yoghurt cultures reduced the fermentation time, improved the organoleptic properties of yoghurt but suppressed the growth of yoghurt cultures.

The handbook on Yoghurt Science and Technology, edited by Tamime and Robinson, published by Woodhead Publishing Limited, (2000), paragraph 5.13 on chemically acidified yoghurt, mentions that the addition of glucono-d-lactone (GDL) to milk can result in the formation of a coagulum at pH<4.6. The end product being referred to as directly or chemically acidified yoghurt. It was noted, however, that while the product resembles yoghurt in its appearance, delicate gel, body and texture, it lacks the typical aroma, flavour and the therapeutic qualities of cultured yoghurt.

Kucukcetin et al, in their article titled “Physicochemical and sensory properties of stirred skim milk yoghurt as influenced by glucono-d-lactone and dry matter”, published in Milchwissenschaft, vol. 65 (2), pages 183-187, describe a study of how glucono-o-lactone (GDL) addition and the dry matter of skim milk affect the physicochemical and sensory properties of stirred yoghurt. They concluded that in the yoghurts produced by adding GDL, less syneresis was observed but the number of grains, the perimeter of grains and the visual roughness increased. High concentrations of GDL (>0.5%) were found to cause a significant decrease in the sensory characteristics of the stirred yoghurt samples, as well as in the firmness and the viscosity.

As illustrated by the above prior art, the addition of glucono-d-lactone (GDL) to milk during the manufacture of a fermented milk product such as yoghurt is known, but was not found desirable. It is therefore not widely applied.

In addition customers of fermented milk products are becoming more and more health-conscious and adverse to the addition of externally added sweeteners or other food additives to dairy products. Furthermore, gluconic acid and glucono-d-lactone are even not allowed as additives in yoghurt in many countries.

EP1443827 states that it has been found that by the use of an oxidase from Microdochium in the preparation of a fermented milk product it has been possible to affect the firmness and sourness of the resulting product. It is described that it is thereby possible to produce a less firm and less sour fermented milk product. However, in industrial practice, the addition of such oxidases is not very suitable for application in an anaerobic fermentation process for the production of fermented milk products since it requires oxygen which is hardly present. In addition peroxides may be generated that may negatively affect the organoleptic properties of the final product, especially by oxidation and deterioration of the milk fat.

It would be an advantage in the art to provide a process allowing the production of a fermented milk product with an increased acidification rate and/or reduced fermentation time and/or to provide a mild tasting fermented milk product

### SUMMARY OF THE INVENTION

The inventors have now surprisingly found that an increased acidification rate, a reduced fermentation time and/or a mild tasting fermented milk product can be obtained by carrying out the fermentation of a milk base in the presence of a glucose-fructose oxidoreductase enzyme.

Accordingly, in a first aspect, the invention provides a process for the preparation of a fermented milk product comprising the steps of:
providing a milk base comprising glucose and fructose; and
fermenting the milk base in the presence of a lactic acid bacterial strain and a glucose-fructose oxidoreductase enzyme.

In a second aspect, the invention provides a starter culture comprising:
one or more lactic acid bacterial strains, preferably including a Streptococcus thermophilus strain and a Lactobacillus delbrueckii subsp. bulgaricus stain; and
a glucose-fructose oxidoreductase enzyme.

In a third aspect, the invention provides for the use of a combination of a lactic acid bacterial strain and a glucose-fructose oxidoreductase enzyme for the production of a fermented milk product.

In a fourth aspect, the invention provides a fermented milk product obtained or obtainable by a process as above, by using a starter culture as above or by using a combination of a lactic acid bacterial strain and a glucose-fructose oxidoreductase enzyme as above.

In a fifth aspect, the invention provides for a fermented milk product comprising lactic acid, gluconic acid and sorbitol. More preferably such a fermented milk product can advantageously comprise the gluconic acid and the sorbitol in a molar ratio of gluconic acid to sorbitol in the range from equal to or more than 10:1 to equal to or less than 1:10. Possibly the fermented milk product can additionally or in the alternative advantageously, the gluconic acid and the lactic acid in a weight ratio of gluconic acid to lactic acid in the range from equal to or more than 10:1 to equal to or less than 1:10; and/or the gluconic acid and the sorbitol in a weight ratio of gluconic acid to sorbitol in the range from equal to or more than 10:1 to equal to or less than 1:10.

As illustrated by the examples, the above allow one to increase acidification rate and/or reduce fermentation time and/or produce a mild tasting fermented milk product.

### BRIEF DESCRIPTION OF THE DRAWINGS

The invention is illustrated by the following FIGURES:

FIG. 1: Relation of the gluconic acid concentration and color of BCP in assay buffer, as applied in examples 2 and 3.

### BRIEF DESCRIPTION OF THE SEQUENCE LISTING

This application contains a Sequence Listing in computer readable form, which is incorporated herein by reference. An overview is provided by Table 1 below.

TABLE 1
Overview of sequence listings:

| SEQ | | | |
|---|---|---|---|
| ID No: | Enzyme Name | Organism | Type |
| SEQ ID | Glucose-fructose | Zymomonas mobilis | Protein |
| No: 1 | oxidoreductase (GFOR) | | |
| SEQ ID | Glucose-fructose | Zymomonas mobilis | Protein |
| No: 2 | oxidoreductase (GFOR) | ssp. pomaceae | |
| | (UniRef90_F8EVW8) | | |

### DETAILED DESCRIPTION OF THE INVENTION

### Definitions

Unless defined otherwise or clearly indicated by context, all technical and scientific terms used herein have the same meaning as commonly understood by one of ordinary skill in the art.

Throughout the present specification and the accompanying claims, the words “comprise” and “include” and variations such as “comprises”, “comprising”, “includes” and “including” are to be interpreted inclusively. That is, these words are intended to convey the possible inclusion of other elements or integers not specifically recited, where the context allows.

The articles “a” and “an” are used herein to refer to one or to more than one (i.e. to one or at least one) of the grammatical object of the article. By way of example, “an element” may mean one element or more than one element. When referring to a noun (e.g. a compound, an additive, etc.) in the singular, the plural is meant to be included. Thus, when referring to a specific moiety, e.g. a “strain”, this means “at least one” of that strain, e.g. “at least one strain”, unless specified otherwise.

When referring to a compound of which several isomers exist (e.g. a D and an L enantiomer), the compound in principle includes all enantiomers, diastereomers and cis/trans isomers of that compound that may be used in the particular aspect of the invention; in particular when referring to such as compound, it includes the natural isomer(s).

Unless explicitly indicated otherwise, the various embodiments of the invention described herein can be cross-combined.

The term “milk” is intended to encompass milks from mammals and plant sources or mixtures thereof. Preferably, the milk is from a mammal source. Mammals sources of milk include, but are not limited to cow, sheep, goat, buffalo, camel, llama, horse or reindeer. In an embodiment, the milk is from a mammal selected from the group consisting of cow, sheep, goat, buffalo, camel, llama, horse and deer, and combinations thereof. Plant sources of milk include, but are not limited to, milk extracted from soy bean, pea, peanut, barley, rice, oat, quinoa, almond, cashew, coconut, hazelnut, hemp, sesame seed and sunflower seed. Soy bean milk is preferred. In addition, the term “milk” refers to not only whole milk, but also skim milk or any liquid component derived thereof or reconstituted milk.

The term “milk base” refers to a base composition, comprising milk or milk ingredients, or derived from milk or milk ingredients. The milk base can be used as a raw material for the fermentation to produce a fermented milk product. The milk base may for example comprise or consist of skimmed or non-skimmed milk, or reconstituted milk. Optionally the milk base may be concentrated or in the form of powder, or may be reconstituted from such. By reconstituted milk is herein understood liquid milk obtained by adding liquid, such as water, to a skim milk powder, skim milk concentrate, whole milk powder or whole milk concentrate. Furthermore, the milk base may or may not have been subjected to a thermal processing operation which is at least as efficient as pasteurization.

As used in this specification, the terms “fermented milk product”, “fermented dairy product” and “acidified milk product” are used interchangeably and are intended to refer to products which are obtained by the multiplication of lactic acid bacteria in a milk base leading to a milk coagulum. The particular characteristics of the various fermented milk products depend upon various factors, such as the composition of milk base, the incubation temperature, the composition of the lactic acid bacteria and/or presence of further non-lactic acid microorganisms. Thus, fermented milk products manufactured herein include, for instance, various types of yoghurt (including for example set yoghurt, low fat yoghurt, non-fat yoghurt), kefir, dahi, ymer, buttermilk, butterfat, sour cream and sour whipped cream as well as fresh cheeses such as quark and cottage cheese. Petit Suisse is yet another example of a fermented dairy product.

The term “yoghurt” refers to products comprising or obtained by means of lactic acid bacteria that include at least Streptococcus salivarius thermophilus and Lactobacillus delbrueckii subsp. bulgaricus, but may also, optionally, include further microorganisms such as Lactobacillus delbrueckii subsp. lactis, Bifidobacterium animalis subsp. lactis, Lactococcus lactis, Lactobacillus acidophilus and Lactobacillus casei, or any microorganism derived therefrom. Such lactic acid strains other than Streptococcus salivarius thermophilus and Lactobacillus delbrueckii subsp. bulgaricus, can give the finished product various properties, such as the property of promoting the equilibrium of the gut microbiota. As used herein, the term “yoghurt” encompasses set yoghurt, stirred yoghurt, drinking yoghurt, heat treated yoghurt and yoghurt-like products. More preferably, the term “yoghurt” encompasses, but is not limited to, yoghurt as defined according to French and European regulations, e.g. coagulated dairy products obtained by lactic acid fermentation by means of specific thermophilic lactic acid bacteria only (i.e. Lactobacillus delbrueckii subsp. bulgaricus and Streptococcus salivarius thermophilus) which are cultured simultaneously and are found to be live in the final product in an amount of at least 10 million CFU (colony-forming unit)/g. Preferably, the yoghurt is not heat-treated after fermentation. Yoghurts may optionally contain added dairy raw materials (e.g. cream) or other ingredients such as sugar or sweetening agents, one or more flavouring(s), fruit, cereals, or nutritional substances, especially vitamins, minerals and fibers. Such yoghurt advantageously meets the specifications for fermented milks and yoghurts of the AFNOR NF 04-600 standard and/or the codex StanA-IIa-1975 standard. In order to satisfy the AFNOR NF 04-600 standard, the product must not have been heated after fermentation and the dairy raw materials must represent a minimum of 70% (m/m) of the finished product.

In the present context, the terms “fresh cheese”, “unripened cheese”, “curd cheese” and “curd-style cheese” are used interchangeably herein to refer to any kind of cheese such as natural cheese, cheese analogues and processed cheese in which the protein/casein ratio does not exceed that of milk.

The term “starter” or “starter culture” as used herein refers to a culture of one or more food-grade micro-organisms, more preferably a culture comprising lactic acid bacteria, which are responsible for the acidification of the milk base. Starter cultures may be fresh (liquid), frozen or freeze-dried. Freeze dried cultures need to be regenerated before use. For the production of a yoghurt, the starter can for example be added in an amount from 0.01 to 3% by weight of the total amount of milk base. For the production of cheese, lower dosages can be used such as from 0.006% by weight of the total amount of milk base.

As used herein, the term “lactic acid bacteria”, “LAB”, “lactic acid bacterial strains” and “lactic bacteria” are used interchangeably and refer to food-grade bacteria producing lactic acid as the major metabolic end-product of carbohydrate fermentation. These bacteria are related by their common metabolic and physiological characteristics and are usually Gram positive, low-GC, acid tolerant, non-sporulating, non-respiring, rod-shaped bacilli or cocci. During the fermentation stage, the consumption of lactose by these bacteria causes the formation of lactic acid, reducing the pH and leading to the formation of a protein coagulum. These bacteria are thus responsible for the acidification of milk and for the texture of the dairy product. As used herein, the term “lactic acid bacteria” or “lactic bacteria” encompasses, but is not limited to, bacteria belonging to the genus of Lactobacillus spp., Bifidobacterium spp., Streptococcus spp., Lactococcus spp., such as Lactobacillus delbrueckii subsp. bulgaricus, Streptococcus salivarius thermophilus, Lactobacillus lactis, Bifidobacterium animalis, Lactococcus lactis, Lactobacillus casei, Lactobacillus plantarum, Lactobacillus helveticus, Lactobacillus acidophilus and Bifidobacterium breve.

The term “enzyme” refers herein to a protein having a catalytic function. Where a protein catalyzes a certain biological reaction, the terms “protein” and “enzyme” may be used interchangeable herein. When an enzyme is mentioned with reference to an enzyme class (EC), the enzyme class is a class wherein the enzyme is classified or may be classified, on the basis of the Enzyme Nomenclature provided by the Nomenclature Committee of the International Union of Biochemistry and Molecular Biology (NC-IUBMB), which nomenclature may be found at http://www.chem.qmul.ac.uk/iubmb/enzyme/. Other suitable enzymes that have not (yet) been classified in a specified class but may be classified as such, are meant to be included.

The terms “polypeptide”, “peptide” and “protein” are used interchangeably herein to refer to a polymer of amino acid residues, for example illustrated by an amino acid sequence. The terms apply to amino acid polymers in which one or more amino acid residue is an artificial chemical analogue of a corresponding naturally occurring amino acid, as well as to naturally occurring amino acid polymers. The terms “polypeptide”, “peptide” and “protein” are also inclusive of modifications including, but not limited to, glycosylation, lipid attachment, sulphation, gamma-carboxylation of glutamic acid residues, hydroxylation and ADP-ribosylation.

The term “functional homologue” (or in short “homologue”) of a polypeptide having a specific amino acid sequence (e.g. “SEQ ID NO: X”), as used herein, refers to a polypeptide comprising said specific amino acid sequence with the proviso that one or more amino acids are mutated, substituted, deleted, added, and/or inserted, but where said polypeptide still has (qualitatively) the same enzymatic functionality for substrate conversion.

Whether two homologous sequences are closely related or more distantly related is indicated by “percent identity” or “percent similarity. To indicate “percent identity” or “percent similarity”, “level of homology” or “percent homology” are frequently used interchangeably. A comparison of sequences and determination of percent identity between two sequences can be accomplished using a mathematical algorithm. The skilled person will be aware of the fact that several different computer programs are available to align two sequences and determine the homology between two sequences (Kruskal et al., “An overview of sequence comparison: Time warps, string edits, and macromolecules”, (1983), Society for Industrial and Applied Mathematics (SIAM), Vol 25, No. 2, pages 201-237 and the handbook edited by Sankoff and J. B. Kruskal, (ed.), “Time warps, string edits and macromolecules: the theory and practice of sequence comparison”, (1983), pp. 1-44, published by Addison-Wesley Publishing Company, Massachusetts USA).

The percent identity between two amino acid sequences can for example be determined using the Needleman and Wunsch algorithm for the alignment of two sequences. (Needleman et al “A General Method Applicable to the Search for Similarities in the Amino Acid Sequence of Two Proteins” (1970) J. Mol. Biol. Vol. 48, pages 443-453). The algorithm aligns amino acid sequences as well as nucleotide sequences. The Needleman-Wunsch algorithm has been implemented in the computer program NEEDLE. For the purpose of this invention the NEEDLE program from the EMBOSS package can be used (version 2.8.0 or higher, see Rice et al, “EMBOSS: The European Molecular Biology Open Software Suite” (2000), Trends in Genetics vol. 16, (6) pages 276-277, http://emboss.bioinformatics.nl/). For protein sequences, EBLOSUM62 can be used for the substitution matrix. For nucleotide sequences, EDNAFULL can be used. Other matrices can be specified. The optional parameters used for alignment of amino acid sequences are a gap-open penalty of 10 and a gap extension penalty of 0.5. The skilled person will appreciate that all these different parameters will yield slightly different results but that the overall percentage identity of two sequences is not significantly altered when using different algorithms.

The homology or identity is the percentage of identical matches between the two full sequences over the total aligned region including any gaps or extensions. The homology or identity between the two aligned sequences is calculated as follows: Number of corresponding positions in the alignment showing an identical amino acid in both sequences divided by the total length of the alignment including the gaps. The identity defined as herein can be obtained from NEEDLE and is labelled in the output of the program as “IDENTITY”.

The homology or identity between the two aligned sequences is calculated as follows: Number of corresponding positions in the alignment showing an identical amino acid in both sequences divided by the total length of the alignment after subtraction of the total number of gaps in the alignment. The identity defined as herein can be obtained from NEEDLE by using the NOBRIEF option and is labelled in the output of the program as “longest-identity”.

### Milk Base Comprising Glucose and Fructose

In the process according to the invention a milk base comprising glucose and fructose is provided.

In addition to the glucose and fructose, the milk base may suitably comprise other ingredients such as water, other sugars (such as for example lactose) and optionally other carbohydrates, lipids, proteins, salts, minerals, and/or vitamins. More preferably the milk base comprises at least lactose, glucose and fructose.

In a preferred embodiment the milk base is a milk base supplemented with a source of glucose and/or fructose. That is, preferably the milk base comprises milk or milk ingredients that has/have been supplemented with a source of glucose and/or fructose. By a source of glucose and/or fructose, i.e. a “glucose and/or fructose source”, is herein understood a direct or indirect source of glucose and/or fructose. The source of glucose and/or fructose can for example comprise glucose and/or fructose and/or a glucose precursor and/or a fructose precursor.

The sucrose and/or fructose can be added to the milk base “in-situ” or “ex-situ”.

For example, the milk base may have been prepared by taking a preceding milk base and supplementing such preceding milk base with a glucose and/or fructose-containing composition, such as a glucose and/or fructose-containing syrup (such as a fructose-containing corn syrup), honey or a fruit preparation. The preceding milk base can for example be supplemented with a composition containing both glucose and fructose, or the milk base can be supplemented with a separate composition containing fructose and/or a separate composition containing glucose. Glucose and/or fructose can be supplemented to the milk base prior to or during fermentation. Preferably the glucose and/or fructose are supplemented to the milk base prior to the fermentation. A milk base comprises milk or milk ingredients that has/have been supplemented with glucose and/or fructose prior to the fermentation is an example of an “ex-situ” prepared milk base comprising glucose and fructose.

Preferably the milk base is a milk base that comprises in-situ generated glucose and/or fructose. For example, the milk base that may originally comprise one or more precursor compound(s) of the glucose and/or fructose, where this precursor compound is conveniently converted into glucose and/or fructose during the fermentation. The advantage of such a milk base comprising in-situ generated glucose and/or fructose is that there is a gradual release of glucose and/or fructose throughout the fermentation and/or the concentrations of glucose and/or fructose during the fermentation can be kept more constant. For example the milk base can advantageously be a milk base comprising milk or milk ingredients that has/have been supplemented with a sucrose source and an invertase enzyme.

By a “sucrose source” is herein understood a source of sucrose. Examples of suitable sources of sucrose include sugarcane and/or sugar beet extract.

The terms “invertase”, “invertase enzyme” and “invertase protein” are used interchangeably herein and refer to a protein having enzymatic glucose-fructose oxidoreductase activity. By an “invertase” is herein understood an invertase enzyme that catalyzes the hydrolysis (breakdown) of sucrose into fructose and glucose. Preferably the invertase is understood herein as an invertase belonging to enzyme classification EC 3.2.1.26. It is also known as beta-fructosidase or under its systematic name as beta-fructofuranosidase. The invertase may for example be derived from a yeast or bifidobacterium. Suitable examples of invertase enzymes include Maxinvert® (commercially available from DSM Food Specialties).

The invertase enzyme may suitably be added prior to or during the fermentation. Conveniently the invertase enzyme can be added as enzyme liquid, enzyme granulate or as frozen enzyme pellets.

The amounts of sucrose, glucose and/or fructose in the provided milk base may vary widely. More preferably the total concentration of sucrose, glucose and/or fructose in the milk base lies in the range from equal to or more than 0.1% (w/w), more preferably equal to or more than 0.5% (w/w), even more preferably equal to or more than 1.0% w/w, still more preferably equal to or more than 2.0% (w/w) and most preferably equal to or more than 5.0% (w/w) to equal to or less than 50.0% (w/w), more preferably equal to or less than 30.0% w/w, even more preferably equal to or less than 20.0% (w/w), still more preferably equal to or less than 15.0% (w/w) and most preferably equal to or less than 10.0% (w/w), based on the total weight of the milk base. For this concentration range, the total weight of the milk base can suitably be understood to refer to the total weight of the raw material present at the start of the fermentation, as illustrated in the examples.

More preferably the milk base is a milk base containing sucrose and invertase and the total concentration of sucrose in the milk base preferably lies in the range from equal to or more than 0.1% (w/w), more preferably equal to or more than 0.5% (w/w), even more preferably equal to or more than 1.0% w/w, still more preferably equal to or more than 2.0% (w/w) and most preferably equal to or more than 5.0% (w/w) to equal to or less than 50.0% (w/w), more preferably equal to or less than 30.0% w/w, even more preferably equal to or less than 20.0% (w/w), still more preferably equal to or less than 15.0% (w/w) and most preferably equal to or less than 15.0% (w/w), based on the total weight of the milk base (i.e. based on the total weight of the milk base, including the sucrose and the invertase contained therein).

### Glucose-Fructose Oxidoreductase

The milk base is fermented in the presence of a lactic acid bacterial strain and a glucose-fructose oxidoreductase enzyme.

The terms “glucose-fructose oxidoreductase”, “glucose-fructose oxidoreductase enzyme“and” glucose-fructose oxidoreductase protein” are used interchangeably herein and refer to a protein having enzymatic glucose-fructose oxidoreductase activity.

By an “glucose-fructose oxidoreductase” is herein understood an glucose-fructose oxidoreductase enzyme that catalyzes the chemical reaction:
D-glucose+D-fructose↔glucono-delta-lactone+D-glucitol.
   Preferably the glucose-fructose oxidoreductase is understood herein as a glucose-fructose oxidoreductase belonging to enzyme classification EC 1.1.99.28.

The product D-glucitol is better known as sorbitol.

In an aqueous environment, such as milk, the D-glucono-delta-lactone formed by the reaction of glucose-fructose oxidoreductase will spontaneously react with water and form D-gluconic acid. The presence of water in the reaction will therefore drive the conversion of glucose and fructose to completion. Whether the D-gluconic acid or the D-gluconate base variant thereof is produced will depend on the acidity of the environment. Without wishing to be bound by any kind of theory, it is believed that at the pH's applicable at the start of and/or during the fermentation of a milk base, such as a pH in the range from 4.20 to 8.00, the product is predominantly present in the gluconic acid form. Hence, preferably at least part of the conversion of glucose to glucono-delta-lactone by the glucose-fructose oxidoreductase enzyme is carried out at a pH where the gluconic acid is present in its acidic form. More preferably at least part of the conversion is carried out at a pH in the range from equal to or more than 4.20, more preferably equal to or more than 4.30, even more preferably equal to or more than 4.40, still more preferably equal to or more than 4.50 or equal to or more than 4.60 and most preferably equal to or more than 4.86 or equal to or more than 5.00 to equal to or less than 8.00, possibly equal to or less than 7.00. Gluconic acid has a pKa of 3.86. Via the Henderson-Hasselbach equation (pH=pKa+log[A−]/[HA]) it can be derived that at a neutral pH of 7, the concentration of gluconic acid is more than 1000 times as high as the concentration of the gluconate base. At a more acid pH of 5, the concentration of gluconic acid is still more than 10 times as high as the concentration of the gluconate base. At an acid pH of 4.2, the concentration of gluconic acid is still more than 2 times as high as the concentration of the gluconate base. Without wishing to be bound by any kind of theory it is believed that the presence of the gluconic acid in addition to, or instead of, the presence of the lactic acid allows for an increased mild taste of the product as explained in detail below.

Hence, preferably at least part of the fermentation is carried out under conditions suitable for the conversion by means of the glucose-fructose oxidoreductase enzyme of glucose to gluconic acid and of fructose to sorbitol.

The conversion of glucose to gluconic acid (whether directly or indirectly via a gluconolactone which is hydrolyzed to gluconic acid) and the conversion of fructose to sorbitol by means of the glucose-fructose oxidoreductase enzyme can be carried out before, in parallel or after the conversion of at least part or the whole of the milk or milk ingredients, such as lactose, into lactic acid. Preferably the milk base comprises glucose, fructose and lactose and preferably the conversion of glucose to gluconic acid (optionally indirectly via a gluconolactone which is hydrolyzed to gluconic acid) and the conversion of fructose to sorbitol by means of glucose-fructose oxidoreductase enzyme is carried out prior to or simultaneously with a conversion of at least part of the lactose to lactic acid by means of the lactic acid bacterial strain. Most preferably the conversion of glucose to gluconic acid (optionally indirectly via a gluconolactone which is hydrolyzed to gluconic acid) and the conversion of fructose to sorbitol by means of glucose-fructose oxidoreductase enzyme is carried simultaneously with or in parallel to a conversion of lactose to lactic acid by means of the lactic acid bacterial strain.

More preferably the process according to the invention is therefore a process for production of a fermented milk product comprising the steps of:
providing a milk base comprising lactose, glucose and fructose; and
fermenting the milk base in the presence of a lactic acid bacterial strain and a glucose-fructose oxidoreductase enzyme,
   wherein the lactose in the milk base is converted by the lactic acid bacterial strain whilst simultaneously the glucose and the fructose are converted by the glucose-fructose oxidoreductase enzyme.

Suitable examples of the glucose-fructose oxidoreductase enzyme include the glucose-fructose oxidoreductase enzyme derived from Zymomonas mobilis that is commercially available from Creative Enzymes®, present in their on-line catalogue as EXWM-0456 (see online catalogue at https://www.creative-enzymes.com/product/glucosefructose-oxidoreductase_10626.html). Alternatively, the enzyme can be prepared as described for example by Zachariou et al., in their article titled “Glucose-fructose oxidoreductase, a new enzyme isolated from Zymomonas mobilis that is responsible for sorbitol production”, published in Journal of Bacteriology, (1986), vol. 167, no. 3, pages 863-869; and by Aziz et al., in their article titled “Biotransformation of pineapple juice sugars into dietetic derivatives by using a cell free oxidoreductase from Zymomonas mobilis together with commercial invertase”, published in Enzyme and Microbial Technology, (2011), vol. 48, pages 85-91.

More preferably the glucose-fructose oxidoreductase enzyme comprises or consists of:
an amino acid sequence of SEQ ID NO: 1 or SEQ ID NO: 2; or
a functional homologue of SEQ ID NO: 1 or SEQ ID NO: 2, having at least 40%, at least 45%, at least 50%, at least 55%, at least 60%, at least 65%, at least 70%, at least 75%, at least 80%, at least 85%, at least 90% at least 95%, at least 98% or at least 99% sequence identity with the amino acid sequence of SEQ ID NO: 1 or SEQ ID NO: 2; or
a functional homologue of SEQ ID NO: 1 or SEQ ID NO: 2, having one or more mutations, substitutions, insertions and/or deletions when compared with the amino acid sequence of SEQ ID NO: 1 or SEQ ID NO: 2, more preferably a functional homologue that has no more than 300, no more than 250, no more than 200, no more than 150, no more than 100, no more than 75, no more than 50, no more than 40, no more than 30, no more than 20, no more than 10 or no more than 5 amino acid mutations, substitutions, insertions and/or deletions when compared with the amino acid sequence of SEQ ID NO: 1 or SEQ ID NO: 2. The glucose-fructose oxidoreductase enzymes comprising or consisting of SEQ ID NO: 1 and SEQ ID NO: 2 are most preferred.

Glucose-fructose oxidoreductase enzymes comprising or consisting of SEQ ID NO: 1 and SEQ ID NO: 2 can for example be produced by bringing them to expression in a micro-organism, preferably a yeast, more preferably a Kluyveromyces lactis yeast, wherein preferably any lactase functionality has been knocked-out. Such an expression of a heterologous protein in a lactase-negative Kluyveromyces lactis strain is for example described by Ooyen et al. in their article titled “Heterologous protein production in the yeast Kluyveromyces lactis”, published in FEMS Yeast Research, (2006), vol. 6, pages 381-392. A (LAC4) lactase knockout strain can for example be prepared as described in literature by Gödecke et al. in their article titled “Coregulation of the Kluyveromyces lactis lactose permease and beta-galactosidase genes is achieved by interaction ofmultiple LAC9 binding sites in a 2.6 kbp divergent promoter”, published in Nucleic Acids Research, (1991), vol. 19, No. 19, pages 5351-5358.

A person skilled in the art is well aware how to harvest such a heterologous protein from the cells. To obtain the enzyme subsequently lysis of the yeast cells can for example be performed with Y-PER, a commercial lysis liquid for yeast commercially obtainable from Thermofisher (see for example https://www.thermofisher.com/order/catalog/product/78991).

Preferably the milk base is contacted with the glucose-fructose oxidoreductase enzyme prior to or during fermentation. For example, the glucose-fructose oxidoreductase enzyme can be added to the milk base prior to, simultaneously with or after the lactic acid bacterial strain. The glucose-fructose oxidoreductase enzyme can be added independently from the lactic acid bacterial strain or the glucose-fructose oxidoreductase enzyme can be added together with the lactic acid bacterial strain. The glucose-fructose oxidoreductase enzyme may further be added batch-wise, semibatch-wise or continuously, for example via in-line blending.

The glucose-fructose oxidoreductase enzyme can suitably be added in any form or shape. For example, the glucose-fructose oxidoreductase enzyme can be added as a liquid, in frozen or freeze-dried form. Preferably the glucose-fructose oxidoreductase enzyme is present as an enzyme liquid, enzyme granulate or as frozen enzyme pellets. Where the lactic acid bacterial cells are added to the milk base in the form of frozen pellets, the glucose-fructose oxidoreductase enzyme is most preferably also added to the milk base in the form of frozen pellets. Preferably these frozen pellets have the shape of solid granules, for example formed by dripping, injecting, spraying, pouring or dispersing enzyme material into a cooling medium/cryogenic liquid at a suitable freezing temperature. Preferably these frozen pellets, respectively these frozen granules have an average diameter between 0.01 and 15 mm. Further preferences are as described in WO 2018/228966, incorporated herein by reference.

The total amount of glucose-fructose oxidoreductase enzyme in the milk base preferably lies in the range from equal to or more than 0.00001% (w/w), equal to or more than 0.0001% (w/w), or equal to or more than 0.001% (w/w), more preferably equal to or more than 0.005% (w/w), even more preferably equal to or more than 0.01% w/w, still more preferably equal to or more than 0.05% (w/w) and most preferably equal to or more than 0.1% (w/w) to equal to or less than 10.0% (w/w), more preferably equal to or less than 5.0% w/w, even more preferably equal to or less than 3.0% (w/w), still more preferably equal to or less than 1.0% (w/w) and most preferably equal to or less than 0.5% (w/w), based on the total weight of the milk base (i.e. based on the total weight of the milk base, including any supplemented sucrose, glucose, fructose and optionally any invertase contained therein).

### Lactic Acid Bacterial Strains

The milk base is fermented in the presence of a lactic acid bacterial strain and a glucose-fructose oxidoreductase enzyme.

More preferably the milk base is fermented in the presence of two or more lactic acid bacterial strains.

Preferably the lactic acid bacterial strain(s) is/are selected from the group consisting of Lactobacillus spp., Bifidobacterium spp., Streptococcus spp., Lactococcus spp. Leuconostoc spp., Pediococcus spp. and Propionibacterium spp.

More preferably, the lactic acid bacterial strain(s) is/are selected from the group consisting of Lactobacillus delbrueckii subsp. bulgaricus, Streptococcus (salivarius) thermophilus, Lactobacillus lactis, Bifidobacterium animalis, Lactococcus lactis, Lactobacillus casei, Lactobacillus plantarum, Lactobacillus helveticus, Lactobacillus acidophilus Bifidobacterium breve and/or combinations thereof. Most preferably the lactic acid bacterial strains comprise or consist of Lactobacillus delbrueckii subsp. bulgaricus and Streptococcus thermophilus.

Preferably the milk base is fermented in the presence of a starter culture comprising at least:
a Streptococcus thermophilus strain; and
a Lactobacillus delbrueckii subsp. bulgaricus stain.

The starter culture can comprise lactic acid bacterial strains consisting of only a Streptococcus thermophilus strain and a Lactobacillus delbrueckii subsp. bulgaricus stain. That is, suitably the milk base can be fermented in the presence of a Streptococcus thermophilus strain and a Lactobacillus delbrueckii subsp. bulgaricus stain as the sole lactic acid bacterial strains. However, more preferably the starter culture comprises lactic acid bacterial strains that include a Streptococcus thermophilus strain and a Lactobacillus delbrueckii subsp. bulgaricus stain and in addition one or more further lactic acid bacterial strain(s). That is, suitably the milk base can be fermented in the presence of a Streptococcus thermophilus strain and a Lactobacillus delbrueckii subsp. bulgaricus stain and one or more further lactic acid bacterial strain(s).

For example, the milk base can be fermented in the presence of a strain of Streptococcus thermophilus, a strain of Lactobacillus delbrueckii spp. bulgaricus and in addition a strain of Lactobacillus acidophilus and/or a strain of Lactococcus lactis spp. lactis.

The total amount of lactic acid bacterial stains in the milk base preferably lies in the range from equal to or more than 0.001% (w/w), more preferably equal to or more than 0.005% (w/w), even more preferably equal to or more than 0.01% w/w, still more preferably equal to or more than 0.05% (w/w) and most preferably equal to or more than 0.1% (w/w) to equal to or less than 10.0% (w/w), more preferably equal to or less than 5.0% w/w, even more preferably equal to or less than 3.0% (w/w), still more preferably equal to or less than 1.0% (w/w) and most preferably equal to or less than 0.5% (w/w), based on the total weight of the milk base (i.e. based on the total weight of the milk base, including any supplemented sucrose, glucose, fructose and optionally any invertase contained therein).

### Starter Culture

The one or more lactic acid bacterial strains and the glucose-fructose oxidoreductase enzyme can be added to the milk base each separately or together. More preferably one or more lactic acid bacterial strains and the glucose-fructose oxidoreductase enzyme or a microbial strain producing glucose-fructose oxidoreductase enzyme are combined in one starter culture. This starter culture can advantageously be contacted with the milk base. This advantageously allows for simultaneous contacting of the one or more lactic acid bacterial strains and the glucose-fructose oxidoreductase enzyme with the milk base.

The present invention therefore also provides a starter culture comprising:
a lactic acid bacterial strain; and
a glucose-fructose oxidoreductase enzyme.

More preferably such a starter culture comprises:
one or more lactic acid bacterial strains, preferably including a Streptococcus thermophilus strain and a Lactobacillus delbrueckii subsp. bulgaricus stain; and
a glucose-fructose oxidoreductase enzyme; and
optionally, an invertase enzyme.

Preferably the starter culture is a frozen starter culture comprising the glucose-fructose oxidoreductase enzyme in the form of separate frozen enzyme pellets.

In analogy, the starter culture is preferably a starter culture that comprises invertase enzyme, preferably in the form of frozen enzyme pellets comprising invertase enzyme. More preferably the starter culture is a frozen starter culture, comprising any glucose-fructose oxidoreductase enzyme and/or any invertase enzyme in the form of frozen pellets. Suitably the frozen glucose-fructose oxidoreductase enzyme and the frozen lactic acid bacterial strains can even be present in the same frozen pellet. Such frozen pellets can for example be prepared by mixing the lactic acid bacterial strains and glucose-fructose oxidoreductase enzyme and subsequently producing frozen pellets therefrom. A frozen pellet comprising both the frozen glucose-fructose oxidoreductase enzyme and lactic acid bacterial strains can be advantageously to allow for addition of both to a milk base in a constant molar or weight ratio.

The invention therefore also provides a kit of parts comprising:
frozen pellets comprising a lactic acid bacterial strain,
frozen pellets comprising a glucose-fructose oxidoreductase enzyme; and
optionally, frozen pellets comprising an invertase enzyme.
   The kit of parts can conveniently be provided in a package, for example with a package size in the range from equal to or more than 1 grams to equal to or less than 1000 kilograms, more preferably in the range from equal to or more than 1 kilograms to equal to or less than 100 kilograms.

Preferably the above starter culture, respectively the above kit of parts, comprises a total weight of one or more lactic acid bacterial strains in the range from equal to or more than 20.0% by weight (w/w), more preferably equal to or more than 40.0% (w/w), even more preferably equal to or more than 50.0% (w/w) and still more preferably equal to or more than 70.0% (w/w) or even equal to or more than 90.0% (w/w) or equal to or more than 95.0% (w/w) to equal to or less than 99.9% (w/w), more preferably equal to or less than 99% (w/w) and possibly equal to or less than 95% (w/w) or even equal to or less than 90% (w/w), based on the total weight of the starter culture, respectively kit of parts.

Preferably the starter culture comprises a total weight of glucose-fructose oxidoreductase enzyme in the range from equal to or more than 0.01% by weight (w/w), more preferably equal to or more than 0.05% (w/w), even more preferably equal to or more than 0.1% (w/w) and still more preferably equal to or more than 0.5% (w/w) or even equal to or more than 1.0% (w/w) or equal to or more than 2.0% (w/w) to equal to or less than 30% (w/w), more preferably equal to or less than 20% (w/w) and possibly equal to or less than 10% (w/w) or even equal to or less than 8% (w/w), based on the total weight of the starter culture.

The remainder of the starter culture can comprise one or more other compounds or materials, such as for example fillers, excipients or protectants, such as cryoprotectants and/or lyoprotectants. These compounds or materials can be added to ensure or increase the stability of the lactic acid bacterial strain(s) or the enzyme(s), for example during long term storage or that are added to improve disability or flowability. Cryoprotectants and/or lyoprotectants can be used to protect the lactic acid bacteria and/or the glucose-fructose oxidoreductase enzyme from damage during freezing and thawing, respectively during freeze-drying. Such a cryoprotectant, respectively lyoprotectant, may be any additive as long as it protects the lactic acid bacterial cells or the enzyme from damage during freezing and thawing, respectively freeze-drying.

Suitable excipients and/or protectants include proteins, carbohydrates including monosaccharides (e.g. galactose, glucose, fructose, D-mannose, sorbose), disaccharides (e.g. lactose, trehalose, sucrose), polysaccharides (e.g. raffinose, starch, gums, celluloses, maltodextrin, cyclodextrin, dextran), polyalcohols (e.g. glycerol, sorbitol, mannitol), polyethers (e.g. polypropylene glycol, polyethylene glycol, polybutylene glycol), antioxidants (e.g. natural antioxidants such as ascorbic acid, beta-carotene, vitamin E, glutathione, chemical antioxidants), oils (e.g. rapeseed oil, sunflower oil, olive oil), surfactants (e.g. Tween® 20, Tween® 80, fatty acids), peptones (e.g. soy peptones, wheat peptone, whey peptone), tryptones, vitamins, minerals (e.g. iron, manganese, zinc), hydrolysates (e.g. protein hydrolysates such as whey powder, malt extract, soy), amino acids (e.g. monosodium glutamate, glycine, alanine, arginine, histidine), nucleobases (e.g. cytosine, guanine, adenine, thymine, uracil, xanthine, hypoxanthine, inosine), yeast extracts (e.g. yeast extracts of Saccharomyces spp., Kluyveromyces spp., or Torula spp.), beef extract, growth factors, and lipids and combinations of all of these.

Preferably, the starter culture has a content of viable lactic acid bacterial cells of at least 1×10⁷ colony forming units (cfu) per gram (g) starter culture, more preferably at least 1×10⁸ cfu/g, more preferably at least 1×10⁹ cfu/g, even more preferably at least 1×10¹⁰ cfu/g, still more preferably at least 1×10¹¹ cfu/g, yet even more preferably at least 1×10¹² cfu/g and most preferably at least 1×10¹³ cfu/g starter culture. The advantage of such high concentrations of lactic acid bacteria in the starter culture is that small amounts of starter culture are sufficient for the inoculation of large amounts of milk base.

Preferably the weight ratio of glucose-fructose oxidoreductase enzyme to lactic acid bacteria, in the starter culture and/or during fermentation, lies in the range from equal to or more than 0.001:1, preferably equal to or more than 0.01:1 to equal to or less than 1:1, more preferably equal to or less than 0.1:1.

### Fermenting

The milk base is fermented in the presence of a lactic acid bacterial strain and a glucose-fructose oxidoreductase enzyme. During this fermentation, the milk base can be acidified.

That is, the invention also provides the use of a combination of a lactic acid bacterial strain and a glucose-fructose oxidoreductase enzyme for the purpose of acidification of a milk base, preferably a milk base comprising lactose, glucose and fructose. Thus the invention provides the use of a combination of a lactic acid bacterial strain and a glucose-fructose oxidoreductase enzyme for the production of a fermented milk product.

More preferably the invention provides the use of a starter culture, comprising a combination of a lactic acid bacterial strain and a glucose-fructose oxidoreductase enzyme for the purpose of acidification and/or fermentation of a milk base, preferably a milk base comprising lactose, glucose and fructose. That is, preferably the invention provides the use of a starter culture, comprising a combination of a lactic acid bacterial strain and a glucose-fructose oxidoreductase enzyme for the production of a fermented milk product.

The process conditions during such acidification, respectively fermentation, can be varied widely.

As described above, the composition of the milk base can be adjusted to arrange for the desired concentrations of lactose, glucose and/or fructose in the milk base. The milk base may further be adjusted to arrange for the desired amounts of fat and/or proteins. If so desired, stabilizers and/or other additives may be added.

The milk base is preferably heated before fermentation thereof. More preferably the milk base is heated at a temperature equal to or more than 80° C., more preferably a temperature equal to or more than 85° C., for a period of preferably equal to or more than 20 minutes, more preferably equal to or more than 30 minutes. In the alternative or in addition, the milk base may be heated at a temperature of equal to or more than 95° C., preferably for a period of equal to or more than 10 minutes. The heat treatments advantageously allow for the elimination of pathogens. In addition, the heat treatments can help to create a better environment for the lactic acid bacterial cells to grow.

Optionally the milk base can be homogenized (e.g. stirred or mixed) before fermentation. Without wishing to be bound by any kind of theory, such homogenization may allow for an improved consistency of the fermented milk product.

After heating and before inoculation of the milk base with the lactic acid bacterial strain(s), the milk base is preferably cooled to the desired fermentation temperature. More preferably the temperature of the milk base is adjusted to a fermentation temperature in the range from equal to or more than 18° C., preferably equal to or more than 22° C. to equal to or less than 45° C., more preferably equal to or less than 42° C.

Fermentation of the milk base can suitably be carried out in a so-called fermentation vat or fermentation tank.

The milk base can be inoculated with the starter culture in any manner known by the person skilled in the art. For example, the starter culture can be dosed batchwise, semi-batchwise or continuously, including for example by inline dosing.

Although the temperature can be adjusted during fermentation, the temperature during fermentation is preferably kept constant. Preferably a constant fermentation temperature is chosen in the range from equal to or more than 18° C., preferably equal to or more than 22° C. to equal to or less than 45° C., more preferably equal to or less than 42° C. During the fermentation the pH decreases. Preferably the fermentation is continued until a certain desired pH, preferably a pH in the range from equal to or more than pH 4.0 to equal to or less than pH 4.8, is reached. More preferably the fermentation is at least continued for a certain period of time until a pH of for example pH 4.8, pH 4.7, pH 4.6, pH 4.5, pH 4.4, pH 4.3, pH 4.2, pH 4.1 or pH 4.0 is reached. The time period until the desired pH is reached is herein also referred to as “acidification time”. The use of the glucose-fructose oxidoreductase enzyme advantageously allows one to shorten the acidification time. That is, the use of the glucose-fructose oxidoreductase enzyme advantageously allows one to reach the same pH in a shorter time period or, alternatively, allows one to reach a lower pH in the same time period. Preferably the time to reach a pH of for example pH 4.6 is equal to or less than 10 hours, more preferably equal to or less than 8 hours, even more preferably equal to or less than 7 hours and most preferably equal to or less than 6 hours.

In the process according to the invention, the time period during which the milk base is fermented (the “fermentation time”) can therefore advantageously be equal to or less than 22 hours, more preferably equal to or less than 20 hours, still more preferably equal to or less than 18 hours, even more preferably equal to or less than 16 hours, still even more preferably equal to or less than 14 hours or even equal to or less than 12 hours. More preferably the milk base is fermented during a time period that is equal to or less than 10 hours, still more preferably equal to or less than 8 hours, even more preferably equal to or less than 7 hours and most preferably equal to or less than 6 hours. Hence advantageously the time period for the fermentation of the milk base in the process according to the invention can lie in the range from equal to more than 3 hours, more preferably equal to or more than 4 hours, still more preferably equal to or more than 5 hours, to equal to or less than 12 hours, more preferably equal to or less than 10 hours, even more preferably equal to or less than 8 hour, still more preferably equal to or less than 7 hours and most preferably equal to or less than 6 hours.

When the desired pH is reached, the fermentation can be stopped in any manner known to the person skilled in the art. Preferably the fermentation is stopped by cooling the fermented milk product, for example by reducing the temperature to a temperature equal to or less than 10° C., more preferably equal to or less than 8° C., and most preferably equal to or less than 7° C. The fermented milk product can suitably be removed from the fermentation vat or fermentation tank.

Optionally the fermented milk product can be stirred and/or fruit and/or flavors can be added to the fermented milk product. Subsequently the fermented milk product can be packaged as desired.

### Fermented Milk Product

The process according to the invention can advantageously be applied to produce a wide range of fermented milk products, including for example various types of yoghurt (such as set yoghurt, stirred yoghurt, low fat yoghurt, non-fat yoghurt), kefir, dahi, ymer, buttermilk, butterfat, sour cream and sour whipped cream as well as fresh cheeses such as quark and cottage cheese.

Advantageously, by using the glucose-fructose oxidoreductase enzyme instead of simply adding gluconolactone, the growth of the lactic acid bacterial strains is not or less suppressed. As a result a fermented milk product is obtained containing considerable amounts of gluconic acid and at the same time containing considerable amounts of lactic acid. In addition, the use of the glucose-fructose oxidoreductase enzyme allows for the simultaneous production of both gluconic acid as well as sorbitol, a natural sweetener.

Due to its unique composition, the fermented milk product as produced by the process according to the invention, can advantageously allow for a mild taste.

Accordingly, a novel fermented milk product is provided comprising lactic acid, gluconic acid and sorbitol, wherein preferably the gluconic acid and the sorbitol are present in a molar ratio of gluconic acid to sorbitol in the range from equal to or more than 10:1 to equal to or less than 1:10, more preferably in a molar ratio of gluconic acid to sorbitol in the range from equal to or more than 5:1 to equal to or less than 1:5, and most preferably in a molar ratio of gluconic acid to sorbitol in the range from equal to or more than 2:1 to equal to or less than 1:2. The gluconic acid and sorbitol may even be present in an equimolar amount.

Further, a novel fermented milk product is provided comprising lactic acid, gluconic acid and sorbitol, wherein preferably
the gluconic acid and the lactic acid are present in a weight ratio of gluconic acid to lactic acid in the range from equal to or more than 10:1 to equal to or less than 1:10, more preferably in a weight ratio of gluconic acid to lactic acid in the range from equal to or more than 5:1 to equal to or less than 1:5, and most preferably in a weight ratio of gluconic acid to lactic acid in the range from equal to or more than 2:1 to equal to or less than 1:2; and/or
the gluconic acid and sorbitol are present in a weight ratio of gluconic acid to sorbitol in the range from equal to or more than 10:1 to equal to or less than 1:10, more preferably in a weight ratio of gluconic acid to sorbitol in the range from equal to or more than 5:1 to equal to or less than 1:5, and most preferably in a weight ratio of gluconic acid to sorbitol in the range from equal to or more than 2:1 to equal to or less than 1:2.

The following examples are offered for illustrative purposes only, and are not intended to limit the scope of the present invention in any way

### EXAMPLES

### Example 1: Production of the GFOR Enzymes

Two different variants of glucose-fructose oxidoreductase (GFOR), named GFOR1 and GFOR2 as listed in table 2, were expressed intracellularly in a lactase-negative Kluyveromyces lactis yeast.

As indicated above, expression of a heterologous protein in a lactase-negative Kluyveromyces lactis strain is for example described by Ooyen et al. in their article titled “Heterologous protein production in the yeast Kluyveromyces lactis”, published in FEMS Yeast Research, (2006), vol. 6, pages 381-392. A (LAC4) lactase knockout strain can for example be prepared as described in literature by Gödecke et al. in their article titled “Coregulation of the Kluyveromyces lactis lactose permease and beta-galactosidase genes is achieved by interaction of multiple LAC9 binding sites in a 2.6 kbp divergent promoter”, published in Nucleic Acids Research, (1991), vol. 19, No. 19, pages 5351-5358.

Suitable GFOR ORF's were cloned into a vector using a Golden Gate reaction, as described for example by Engler et al., “Generation of Families of Construct Variants Using Golden Gate Shuffling”, (2011), published in chapter 11 of Chaofu Lu et al. (eds.), cDNA Libraries: Methods and Applications, Methods in Molecular Biology, vol. 729, pages 167-180, incorporated herein by reference. Transformation into the lactase-negative Kluyveromyces lactis was carried out via electroporation.

The enzymes GFOR1 and GFOR2 were isolated from the cells and cell free extracts (CFE's) comprising the GFOR enzymes were used for testing. As indicated above, such harvesting of a heterologous protein from the cells can conveniently be carried out via lysis of the yeast cells for example by means of Y-PER, a commercial lysis liquid for yeast commercially obtainable from Thermofisher (see for example https://www.thermofisher.com/order/catalog/product/78991).

TABLE 2
GFOR enzymes as used in the examples

| Enzyme | Amino acid sequence |
|---|---|
| GFOR1 | SEQ ID NO: 1 |
| GFOR2 | SEQ ID NO: 2 |

### Example 2: Effect of GFOR on Acidification in Sugar Solutions

To assess whether the GFOR1 and GFOR2 enzymes were able to acidify, a spectrophotometric assay in a microtiter plate was set up. The assay made use of the pH indicator bromocresol purple (BCP), which changes from purple (pH 6.8) to yellow (pH 5.2). This pH change was monitored by reading the absorbance at 590 nm (purple) and at 432 nm (yellow) during the incubation of the enzymes with the substrate.

An activity assay was developed that was based on acidification and measurement of pH change using such bromocresol purple (BCP). From neutral to acidic the dye changed in color from purple to yellow. Hence, acidification could be followed by either measuring the increase in yellow color (Absorbance at 432 nm, further “Δ432”) or the decrease in purple color (Absorbance at 590 nm, further “Δ590”).

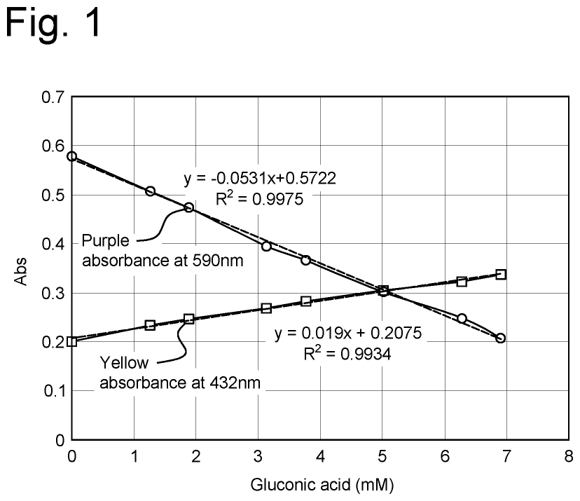

A pH calibration line was taken along when running the acidification capacity assay, which consisted of 10 mM MES buffer at known pH's with BCP 2% solution. This gave a color scale to which the results could be related. First the relation between the pH versus color, and gluconic acid concentration and color in the assay buffer was tested as illustrated in FIG. 1. It was found that an absorption of A432: 0.2-0.35 gives a good relation between the gluconic acid concentration, pH and color development. For A590 this relation was good between 0.55 and 0.25.

The incubation for the GFOR samples consisted of: 70 μL substrate, 70 μL 10 mM MES buffer at pH ˜6.5, 5 μL BCP 2% solution and 5 μL sample. During an incubation of 2 h at 40° C. in the SPARK MTP reader, absorbance measurements were taken every minute. Per sample, a blank incubation was run which did not contain substrate but water instead. A decrease in the purple color (−Δ Absorbance at 590 nm, further “Δabs590”) and an increase on the yellow color (+Δ Absorbance at 432 nm, further “ΔAbs432”) indicated acidification had taken place.

Each of the GFOR1 enzyme and the GFOR2 enzyme was screened in triplicate in MTP for acid formation using BCP and measured in time using A432 and A590. Two different substrates were tested: the combination of glucose and galactose, and the combination of glucose and fructose. Controls were either without substrate or without enzyme. None of the controls showed a change in color in time. Thereafter, the median of all control measurements was used to correct all absorption measurements.

The results are shown in Table 3 below. The median of the control measurements is listed as “control”. As illustrated by Table 3, both GFOR1 and GFOR2 containing cell-free extracts showed only activity (i.e. an increase in yellow color, measured as ΔAbs432) in the presence of glucose and fructose, but no activity on glucose plus galactose. The ΔAbs432, representing the formation of gluconic acid in time, is provided in Table 3 below, calculated as μM/min.

It was noted that even though mere very small amounts of glucose-fructose oxidoreductase enzyme (GFOR1 or GFOR2) could be detected in the cell free extracts (CFE's), it was surprising that the enzymes, which had apparently relatively low expression, gave such high activity.

TABLE 3
ΔAbs432, representing the formation of gluconic acid in time, calculated as μM/min

| | Enzyme | | | | | | | | | |
|---|---|---|---|---|---|---|---|---|---|---|
| | | | | | Glucose | Glucose | Glucose | Galactose | Galactose | Fructose |
| | | | | | & | & | & | & | & | & |
| Feed | glucose | galactose | fructose | lactose | galactose | fructose | lactose | fructose | lactose | lactose |
| control | 0 | 0 | 0 | −2 | −4 | −2 | 0 | −1 | −1 | 0 |
| GFOR1 | 0 | 0 | 2 | −1 | 4 | 89 | 0 | 16 | 0 | 25 |
| GFOR2 | 0 | 1 | 2 | −1 | −5 | 117 | −2 | 17 | 0 | 29 |

### Example 3: Effect of GFOR on Acidification in Sugared Milk

In order to mimic application conditions, the two GFOR enzymes, GFOR1 and GFOR2, were tested for their effect in skimmed milk. To a skimmed milk substrate, a combination of 2.5% by weight of glucose and fructose was added. The GFOR enzymes were tested at a temperature of 30° C. and at a temperature of 42° C. Acidification was followed in time using the BCP assay in MTP plate as described in example 2 and absorbance was measured at 432 nm.

All control samples (skim milk without added sugars or without added enzyme sample) show a slight decrease in Δ423 (i.e. an increase in pH) during 60 minutes incubation, exemplified by the slight negative slope (ΔA432 nm/min) of the controls in Table 4. The incubations where GFOR samples were added show however a clear increase in acidification in the presence of glucose and fructose, illustrating the formation of gluconic acid.

TABLE 4
Gluconic acid formation in time in skimmed
milk supplemented with glucose and fructose

| | | ΔAbs432 | Gluconic acid |
|---|---|---|---|
| | Temperature | development in time | formation in time |
| | (° C.) | (nm/min) | (μM/min) |
| Control | 30 | −0.0003 | −14 |
| GFOR1 | 30 | 0.0015 | 81 |
| GFOR2 | 30 | 0.0022 | 115 |
| Control | 42 | −0.0004 | −24 |
| GFOR1 | 42 | 0.0029 | 154 |
| GFOR2 | 42 | 0.0026 | 139 |

### Example 4: Effect of GFOR on Acidification in Yoghurt Production

Subsequently the GFOR1 and GFOR2 enzymes were tested for acidification during yoghurt production from a sugared milk base. For this purpose sucrose was dissolved to 7% (w/w) in cow's milk, thus providing a sugared milk, and the sugared milk was pasteurized for 30 min at 85° C. This milk base (i.e. the sugared milk) was cooled to 42° C. and divided into 95 ml portions.

A yoghurt culture comprising lactic acid bacterial strains Streptococcus thermophilus and Lactobacillus delbrueckii subsp. bulgaricus (a blend similar to the Delvo® Fresh YS-131 product commercially available from DSM Food Specialties) was added at a concentration corresponding to 2 units/1000 litres (2 U/1000 L) together with the tested enzyme additions to a total volume of 5 ml.

The acidification during yoghurt production was determined with the help of a CINAC system (CINetic ACidification). In this system a pH meter is connected to a computer recorder and pH is continuously recorded as a function of time to obtain sigmoidal curves representing the acidification. During the follow-up of the pH, the milk is maintained at fermentation temperature in a thermoregulated bath.

As reference the acidification is used wherein no enzyme additives were added (exp. 4a). Control yoghurts (exp. 4b) contained a similar amount of a cell lysate of a strain that was not expressing any GFOR.

In some samples (exp. 4c, 4f and 4g) Maxinvert® L15,000, an invertase commercially available from DSM Food Specialties, was included until 30 SU/ml. In other samples (exp 4d, 4e, 4f and 4g), glucose-fructose oxidoreductase enzyme (GFOR1 or GFOR2 as indicated in table 5) were included.

The pH was followed in time and the time (minutes) required to reach a pH 4.6 was recorded. All incubations were performed in duplicate. The result is shown in Table 5.

The average acidification time in this case, that is the average Time To Reach pH 4.6 (“TTR4.6”), and the % coefficient of variation (% CV) were calculated and are also listed in Table 5.

As illustrated by Table 5, especially exp. 4d and 4f, the addition of glucose-fructose oxidoreductase enzyme, respectively GFOR1 and GFOR2, allows one to reduce the acidification time by respectively 22% and 27%. When the acidification of the milk base was carried out in the presence of both the lactic acid bacterial strains and the glucose-fructose oxidoreductase enzyme, the time to reach a pH 4.6 was less than 6 hours.

TABLE 5
Time required until pH 4.6 is reached (“TTR4.6”) expressed
in minutes

| | | | TTR4.6 | Average | | |
|---|---|---|---|---|---|---|
| | | TTR4.6 | in | TTR4.6 | | % of |
| | Enzyme | in | minutes | in | | reference |
| Exp. | Additives | minutes | (duplo) | minutes | % CV | time |
| 4a | None | 455 | 438 | 447 | 2.69% | 100% |
| | (reference) | | | | | |
| 4b | Control | 408 | 423 | 416 | 2.55% | 93% |
| 4c | Maxinvert ® | 415 | 410 | 413 | 0.86% | 92% |
| 4d | GFOR01 | 345 | 354 | 350 | 1.82% | 78% |
| 4e | GFOR02 | 326 | 327 | 327 | 0.22% | 73% |
| 4f | Maxinvert ® + | 351 | 330 | 341 | 4.36% | 76% |
| | GFOR01 | | | | | |
| 4g | Maxinvert ® + | 353 | 361 | 357 | 1.58% | 80% |
| | GFOR02 | | | | | |

* % CV = % coefficient of variation

### Example 5: Sensory Testing

After the yoghurt acidification has reached a pH4.6, the yoghurt can be texturized by pumping the yoghurt through a sieve and cooling it to 4° C., before packaging and refrigerated storage. The organoleptic properties of the different yoghurt samples can be tested after 3 days of storage and it can be found that the yoghurts treated with both GFOR preparations taste milder than the control yoghurts.

### Example 6: Composition of Yoghurt

At the end of the CINAC experiment of example 4, that is, at the end of the run, after about 17 hours, samples of the produced fermented milk product, that is of the produced yoghurt, were taken for analysis.

The yoghurt samples were analyzed by High-Performance Anion-Exchange Chromatography with Pulsed Amperometric Detection (HPAEC-PAD) to determine the content of sugars (galactose, glucose, sucrose, fructose and lactose), polyols (sorbitol) and organic acids (lactic acid and gluconic acid). The results are provided in Table 6. The content was expressed in grams per kilogram (g/kg)

As illustrated by control exp. 4b and exp. 4d and 4e in Table 6, the cell extracts produced from the K. lactis yeast in example 1, inherently already contained some invertase activity, resulting in a hydrolysis of the sucrose into glucose and fructose, even in the absence of the invertase Maxinvert®.

As illustrated by exp. 4d, 4e, 4f and 4g, the experiments carried out in the presence of the glucose-fructose oxidoreductase enzymes, respectively GFOR1 and GFOR2, resulted in higher sorbitol and gluconic acid contents vis-à-vis the reference. The lactic acid content in exp. 4d, 4e, 4f and 4g is lower than that for the reference, but advantageously lactic acid is still present, illustrating that the grow of the lactic acid bacterial strains is not inhibited and allowing the fermented milk product, in this case the yoghurt, to maintain sufficient yoghurt (i.e. lactic acid) flavor.

As illustrated by exp. 4f and 4g, addition of the invertase Maxinvert® allows for full hydrolysis of the added sucrose and thereby further stimulates the activity of the glucose-fructose oxidoreductase enzymes, respectively GFOR1 and GFOR2. As shown in Table 6, the addition of the invertase Maxinvert® advantageously results in a further increase of gluconic acid content and sorbitol content, whilst advantageously sufficient lactic acid flavor is maintained.

TABLE 6
Composition of yoghurt samples produced in Example 4. Content is expressed as g/kg

| | | | | | | | | Lactic | Gluconic |
|---|---|---|---|---|---|---|---|---|---|
| Exp. | Additives | Sorbitol | Galactose | Glucose | Sucrose | Fructose | Lactose | acid | acid |
| 4a | none | <0.1 | 1.7 | 0.2 | 69.2 | 0.8 | 38.0 | 4.7 | <0.1 |
| 4b | control | <0.1 | 0.7 | 30.9 | 5.9 | 29.3 | 34.9 | 4.5 | 0.5 |
| 4c | Maxinvert ® | <0.1 | 2.3 | 37.7 | <0.1 | 41.2 | 34.9 | 5.1 | <0.1 |
| 4d | GFOR1 | 6.1 | 0.6 | 27.5 | 4.7 | 24.0 | 36.4 | 3.6 | 7.1 |
| 4e | GFOR2 | 8.6 | 0.6 | 24.1 | 6.0 | 20.6 | 36.1 | 3.4 | 10.2 |
| 4f | Maxinvert ® + | 14.3 | 0.4 | 24.9 | <0.1 | 25.0 | 37.6 | 2.4 | 16.6 |
| | GFOR1 | | | | | | | | |
| 4g | Maxinvert ® + | 16.6 | 0.6 | 23.4 | <0.1 | 23.4 | 37.0 | 2.5 | 19.7 |
| | GFOR2 | | | | | | | | |

### LITERATURE LIST

Fly et al, “Use of glucono-delta-lactone in the manufacture of yoghurt”, published in the Australian Journal of Dairy Technology, vol. 52 (1997) page 20-23.
Yoghurt Science and Technology, edited by Tamime and Robinson, published by Woodhead Publishing Limited, (2000), paragraph 5.13 on chemically acidified yoghurt.
Kucukcetin et al, “Physicochemical and sensory properties of stirred skim milk yoghurt as influenced by glucono-d-lactone and dry matter”, (2010), Milchwissenschaft, vol. 65 (2), pages 183-187.
EP1443827
Kruskal et al., “An overview of sequence comparison: Time warps, string edits, and macromolecules”, (1983), Society for Industrial and Applied Mathematics (SIAM), Vol 25, No. 2, pages 201-237.
Sankoff and J. B. Kruskal, (ed.), “Time warps, string edits and macromolecules: the theory and practice of sequence comparison”, (1983), pp. 1-44, published by Addison-Wesley Publishing Company, Massachusetts USA).
Needleman et al “A General Method Applicable to the Search for Similarities in the Amino Acid Sequence of Two Proteins” (1970) J. Mol. Biol. Vol. 48, pages 443-453.
Rice et al, “EMBOSS: The European Molecular Biology Open Software Suite” (2000), Trends in Genetics vol. 16, (6) pages 276-277, http://emboss.bioinformatics.nl/).
Zachariou et al., “Glucose-fructose oxidoreductase, a new enzyme isolated from Zymomonas mobilis that is responsible for sorbitol production”, published in Journal of Bacteriology, (1986), vol. 167, no. 3, pages 863-869
Aziz et al., “Biotransformation of pineapple juice sugars into dietetic derivatives by using a cell free oxidoreductase from Zymomonas mobilis together with commercial invertase”, published in Enzyme and Microbial Technology, (2011), vol. 48, pages 85-91
Ooyen et al., “Heterologous protein production in the yeast Kluyveromyces lactis”, published in FEMS Yeast Research, (2006), vol. 6, pages 381-392
Gödecke et al., “Coregulation of the Kluyveromyces lactis lactose permease and beta-galactosidase genes is achieved by interaction of multiple LAC9 binding sites in a 2.6 kbp divergent promoter”, published in Nucleic Acids Research, (1991), vol. 19, No. 19, pages 5351-5358.
WO 2018/228966.

1. A process for production of a fermented milk product comprising:
providing a milk base comprising glucose and fructose; and
fermenting the milk base in the presence of a lactic acid bacterial strain and a glucose-fructose oxidoreductase enzyme.

2. The process according to claim 1, wherein the milk base comprises lactose, glucose and fructose.

3. The process according to claim 1, wherein the milk base comprises milk or milk ingredients that has/have been supplemented with a sucrose source and an invertase enzyme.

4. The process according to claim 3, wherein the invertase is added prior to or during the fermentation.

5. The process according to claim 1, wherein the glucose-fructose oxidoreductase enzyme is added to the milk base as an enzyme liquid, enzyme granulate or as frozen enzyme pellets.

6. The process according to claim 1, wherein at least part of the fermentation is carried out under conditions suitable for the conversion by means of the glucose-fructose oxidoreductase enzyme of glucose to gluconic acid and of fructose to sorbitol.

7. The process according to claim 1, wherein the glucose-fructose oxidoreductase enzyme is added to the milk base, prior to or during fermentation.

8. The process according to claim 1, comprising:
providing a milk base comprising lactose, glucose and fructose; and
fermenting the milk base in the presence of a lactic acid bacterial strain and a glucose-fructose oxidoreductase enzyme, wherein the lactose in the milk base is converted by the lactic acid bacterial strain whilst simultaneously the glucose and the fructose are converted by the glucose-fructose oxidoreductase enzyme.

9. The process according to claim 1, wherein the milk base is fermented in the presence of at least:
a Streptococcus thermophilus strain; and
a Lactobacillus delbrueckii subsp. bulgaricus stain.

10. A starter culture comprising:
a lactic acid bacterial strain; and
a glucose-fructose oxidoreductase enzyme.

11. The starter culture according to claim 10, wherein the starter culture further comprises invertase enzyme.

12. A kit of parts comprising:
frozen pellets comprising a lactic acid bacterial strain,
frozen pellets comprising a glucose-fructose oxidoreductase enzyme; and
optionally, frozen pellets comprising an invertase enzyme.

13. (canceled)

14. A fermented milk product, obtained or obtainable by a process comprising providing a milk base comprising glucose and fructose, and fermenting the milk base in the presence of a lactic acid bacterial strain and a glucose-fructose oxidoreductase enzyme.

15. A fermented milk product comprising lactic acid, gluconic acid and sorbitol, wherein the gluconic acid and the sorbitol are present in a molar ratio of gluconic acid to sorbitol in the range from equal to or more than 10:1 to equal to or less than 1:10.

16. A fermented milk product comprising lactic acid, gluconic acid and sorbitol, wherein
the gluconic acid and the lactic acid are present in a weight ratio of gluconic acid to lactic acid in the range from equal to or more than 10:1 to equal to or less than 1:10; and/or
the gluconic acid and sorbitol are present in a weight ratio of gluconic acid to sorbitol in the range from equal to or more than 10:1 to equal to or less than 1:10.


SEQUENCE LISTING (2 sequences)

SEQ ID NO: 1 - protein, 433 aa, Zymomonas mobilis
  REGION 1..433: note = Amino acid sequence of GFOR1 derived from Zymomonas mobilis
MTNKISSSDNLSNAVSATDDNASRTPNLTRRALVGGGVGLAAAGALASGLQAATLPAGASQVPTTPAGRPMPYAIRPMPEDRRFGYAIVGLGKYALNQILPGFAGCQHSRIEALVSGNAEKAKIVAAEYGVDPRKIYDYSNFDKIAKDPKIDAVYIILPNSLHAEFAIRAFKAGKHVMCEKPMATSVADCQRMIDAAKAANKKLMIGYRCHYDPMNRAAVKLIRENQLGKLGMVTTDNSDVMDQNDPAQQWRLRRELAGGGSLMDIGIYGLNGTRYLLGEEPIEVRAYTYSDPNDERFVEVEDRIIWQMRFRSGALSHGASSYSTTTTSRFSVQGDKAVLLMDPATGYYQNLISVQTPGHANQSMMPQFIMPANNQFSAQLDHLAEAVINNKPVRSPGEEGMQDVRLIQAIYEAARTGRAVNTDWGYVRQGGY

SEQ ID NO: 2 - protein, 441 aa, Zymomonas mobilis
  REGION 1..441: note = Amino acid sequence of GFOR2 derived from Zymomonas mobilis subspecies pomaceae
  source 1..441: note = subspecies pomaceae
MTDNISSSDNTEATSSPNTVDKASLSKNTPDMTRRALMGGGMGLAAAGALASGLSASKAQAALPPEVNQVPLTPAGRPIPYAIRPMPEDRRFGYAIVGLGKYALNQILPGFAGCQHSRIEALVSGNAGKAKMVAAEYGVDPRKIYNYDNFDKIANDPKIDAVYIILPNSLHAEFAVRAFKAGKHVMCEKPMATSVADCQRMIAAGKAANKKLMIGYRCHYDPMNRAAVQLIRDNQLGKLGMVTTDNSDVMDPNDPAQQWRLRHALAGGGSMMDIGIYGLNGTRYLLGEEPIEVRATIYSDPNDDRFREVEDRIMWQMRFRSGALAHGASSYSTTTTSRFSVQGDKAVLLMDPATGYYQNLISVQTPGHANQSMMPQFIMPANNQFSAQLDHLAEAVLNNTAVRSPGEEGMQDVRLIMAFYEAARTGRPVNTDWGYVRQGGY